(19) United States
(12) Patent Application Publication
(10) Pub. No.: US 2012/0246707 A1
(43) Pub. Date: Sep. 27, 2012

(54) METHOD FOR INDICATING ABNORMAL DATA-INPUTTING BEHAVIOR

(76) Inventors: Rong-Ching WU, Kaohsiung (TW); Jiuan-Huei Ho, Kaohsiung (TW); Chun-Wei Tseng, Kaoshiung (TW); Chiung-Chang Shieh, Kaohsiung (TW)

(21) Appl. No.: 13/106,358

(22) Filed: May 12, 2011

(30) Foreign Application Priority Data
Mar. 25, 2011 (TW) 100110349

(51) Int. Cl. H04L 9/32; G06F 21/00

(52) U.S. Cl. 726/7

(57) ABSTRACT

A method for indicating abnormal data-inputting behavior includes inducting and connecting an identification end with a control system. The control system receives a procedure selecting command to allow input of registration data or a log-in data. The control system generates identification information based on the registration data when the procedure selecting command is the input of registration data. The identification information is stored in the identification end and includes the registration data, a template of keystroke, and an identification code. The control system generates a keystroke dynamic based on the long-in data when the procedure selecting command is the input of log-in data. The control system compares the keystroke dynamic of the log-in data with the template of keystroke of the identification information. The control system sends out a warning message when the keystroke dynamic of the log-in data does not match the template of keystroke of the identification information.

### BACKGROUND OF THE INVENTION

1. Field of the Invention

The present invention relates to a method for indicating abnormal data-inputting behavior and, more particularly, to a method for indicating abnormal data-inputting behavior based on behavioral features.

2. Description of the Related Art

Due to the booming development of computers and networks, people can obtain information and service more conveniently. Passwords are generally used in computer systems, such as personal computers, transaction platforms, security systems, or automated-teller machines, to identify the authorized users. However, the passwords are liable to be cracked, side-recoded, or counterfeited, such that an unauthorized user can pass the identification procedure by simply inputting the correct passwords. Some identification systems use smart cards as an auxiliary security mechanism, wherein a card reader reads a contact type or non-contact type card to identify the owner of the card.

Furthermore, the biological features and behavioral features are unique to each person. The biological features, such as fingerprints, iris, or facial features, are less apt to change over time. Each person has unique styles in their behavioral features, such as voices or keystroke dynamics. Thus, the biological features and behavioral features can be utilized to recognize the user.

FIG. 1 shows a conventional method for indicating abnormal data-inputting behavior disclosed in Taiwan Patent No. 1245205 entitled “NEURAL NETWORK-BASED ATM MONITORING SYSTEM FOR PREVENTING OF UNAUTHORIZED WITHDRAWAL AND PROVIDING EARLY WARNING”. A card reader unit 91 reads the serial number of an ATM card. After a user inputs the password, an image pick-up unit 92 is activated to take an image of the face of the user. The primary features of the image of the face of the user are extracted by a feature extracting unit 93 and inputted to a neural network training/identifying unit 94. After completion of the neural network sorting training, the neural network weighted data of the primary features of the image of the face of the user are stored in a feature/weighted database unit 95. When the user is intended to withdraw money from an ATM, an output unit 96 proceeds with the service of the ATM if the user inputs the correct password and passes the image identification. Otherwise, an early warning/monitoring unit 97 sends out a warning signal to a monitor staff. The monitor staff can check up the image of the person operating the ATM and do proper handling.

However, errors in the identification results are liable to occur due to swaying of the body of the user while the image pick-up unit 92 operates, providing low reliability in identifying the user. Furthermore, the image of the face of the user is static and, thus, can be easily counterfeited to access the ATM through input of the correct password. Furthermore, the neural network weighted data of the primary features of the image of the face of the user is huge and, thus, can not be stored in the ATM card. Further, the user can not secretly inform the monitor staff, such as the police, if the user is forced to withdraw money under the threat from a gangster.

Thus, a need exists for a method for indicating abnormal data-inputting behavior that provides highly reliable identification, that prevents the identification information from being easily counterfeited, that the identification information is portable to the user, and that can send out a warning massage.

### SUMMARY OF THE INVENTION

An objective of the present invention is to provide a method for indicating abnormal data-inputting behavior by storing the identification information in an identifying device and providing a highly reliable identification result.

Another objective of the present invention is to provide a method for indicating abnormal data-inputting behavior by using the behavioral features as the identification information, such that the identification information can not be counterfeited easily.

A further objective of the present invention is to provide a method for indicating abnormal data-inputting behavior in which the amount of data required to be stored is small, allowing the data to be carried by the user.

The present invention fulfills the above objectives by providing a method for indicating abnormal data-inputting behavior including an induction/connecting procedure, a selection procedure, a registration procedure, and a log-in procedure. In the induction/connecting procedure, a control system inducts and connects with an identification end. In the selection procedure, the control system receives a procedure selecting command to allow input of registration data or a log-in data according to a type of the procedure selecting command received. In the registration procedure, the control system generates identification information based on the registration data when the procedure selecting command is the input of registration data. The identification information is stored in the identification end. The identification information includes the registration data, a template of keystroke, and an identification code. In the log-in procedure, the control system generates a keystroke dynamic based on the long-in data when the procedure selecting command is the input of log-in data. The control system compares the keystroke dynamic of the log-in data with the template of keystroke of the identification information. The control system sends out a warning message when the keystroke dynamic of the log-in data does not match the template of keystroke of the identification information.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a flowchart illustrating a conventional method for indicating abnormal data-inputting behavior.

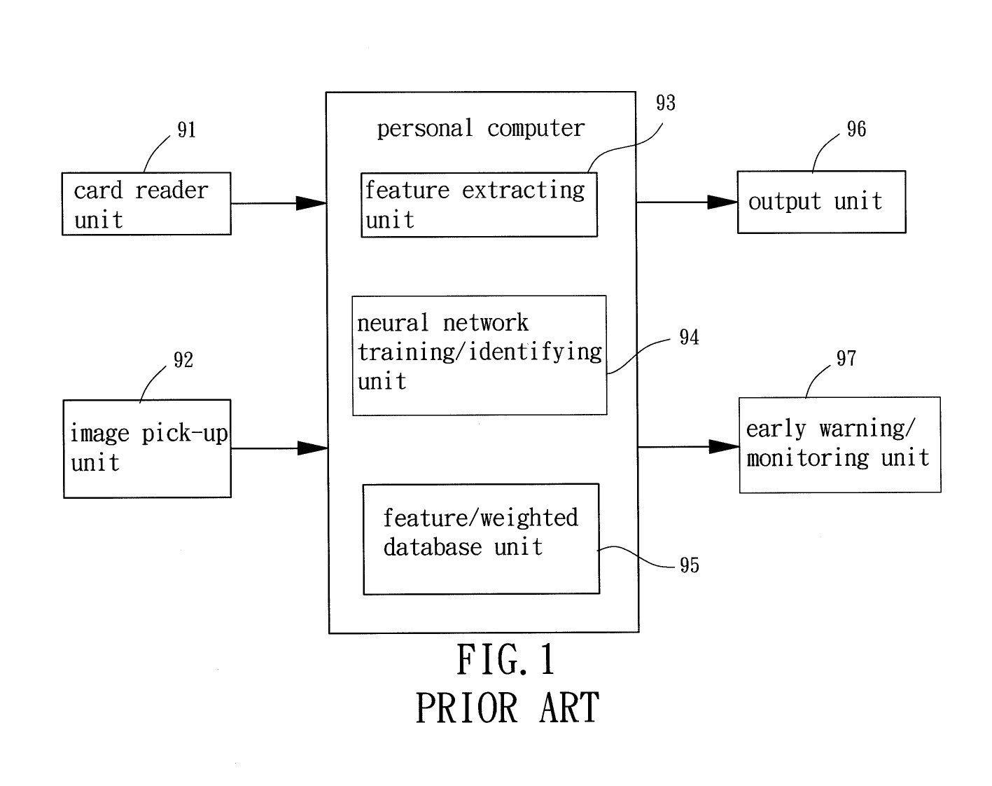

FIG. 2 shows a schematic diagram of a system for carrying out an embodiment of a method for indicating abnormal data-inputting behavior according to the present invention.

FIG. 3 shows a flowchart of an embodiment of the method for indicating abnormal data-inputting behavior according to the present invention.

FIG. 4 shows a flowchart of a registration procedure of an embodiment of the method for indicating abnormal data-inputting behavior according to the present invention.

FIG. 5 shows a diagram of statistic of keystroke dynamics of registration data of the method for indicating abnormal data-inputting behavior according to the present invention.

FIG. 6 shows a flowchart of a log-in procedure of an embodiment of the method for indicating abnormal data-inputting behavior according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

The term “coupled to” used herein refers to physical wire connection or wireless connection for providing a transmission medium for signals or the like.

The term “registration” used herein refers to a procedure in which a user inputs data (such as the account, password, personal data, or a combination of specific characters) while using a control system for the first time, such that the control system can confirm the identity of the user.

The term “long-in” used herein refers to a procedure in which the user, having completed the “registration” on the control system, uses the control system again, wherein the user inputs data (such as the account or password) such that the control system can identify the user.

The term “procedure selecting command” used herein refers to a procedure in which the user sends a command to select a procedure to be carried out by the control system.

The term “key-in” used herein refers to a procedure in which the user inputs data through a keypad or a touch screen through keystrokes.

The term “keystroke dynamic” used herein refers to a behavioral feature dynamic (such as a rhythm of the keystrokes, speeds, or time gaps) produced by the user during the key-in procedure.

The term “down-up time” (DU) used herein refers to one of the time values of the keystroke dynamic, which is the period of time from the moment a key is pressed to the moment the key is released, such as the period of time from the moment the F key is pressed to the moment the F key is released. The unit of the down-up time is mini second (ms).

The term “down-down time” (DD) used herein refers to one of the time values of the keystroke dynamic, which is the period of time from the moment a key is pressed to the moment the next key is pressed, such as the period of time from the moment the F key is pressed to the moment the G key is pressed. The unit of the down-down time is mini second (ms).

The term “up-down time” (UD) used herein refers to one of the time values of the keystroke dynamic, which is the period of time from the moment a key is released to the moment the next key is pressed, such as the period of time from the moment the F key is released to the moment the G key is pressed. The unit of the up-down time is mini second (ms).

The term “up-up time” (UU) used therein refers to one of the time values of the keystroke dynamic, which is the period of time from the moment a key is released to the moment the next key is released, such as the period of time from the moment the F key is released to the moment the G key is released. The unit of the up-up time is mini second (ms).

The term “total-time” (TT) used herein refers to one of the time values of the keystroke dynamic, which is the period of time from the moment the first key is pressed to the moment the last key is released. For example, when inputting “F123G” by a keyboard, the total-time is the period of time from the moment F key is pressed to the moment G key is released. The unit of the total-time is mini second (ms).

The term “template of keystroke” used herein refers to the template deduced from a plurality of keystroke dynamics obtained from repeated input of the same paragraph by the user. Since the typing habits of various users are different from one another, the template of keystroke of the user is unique.

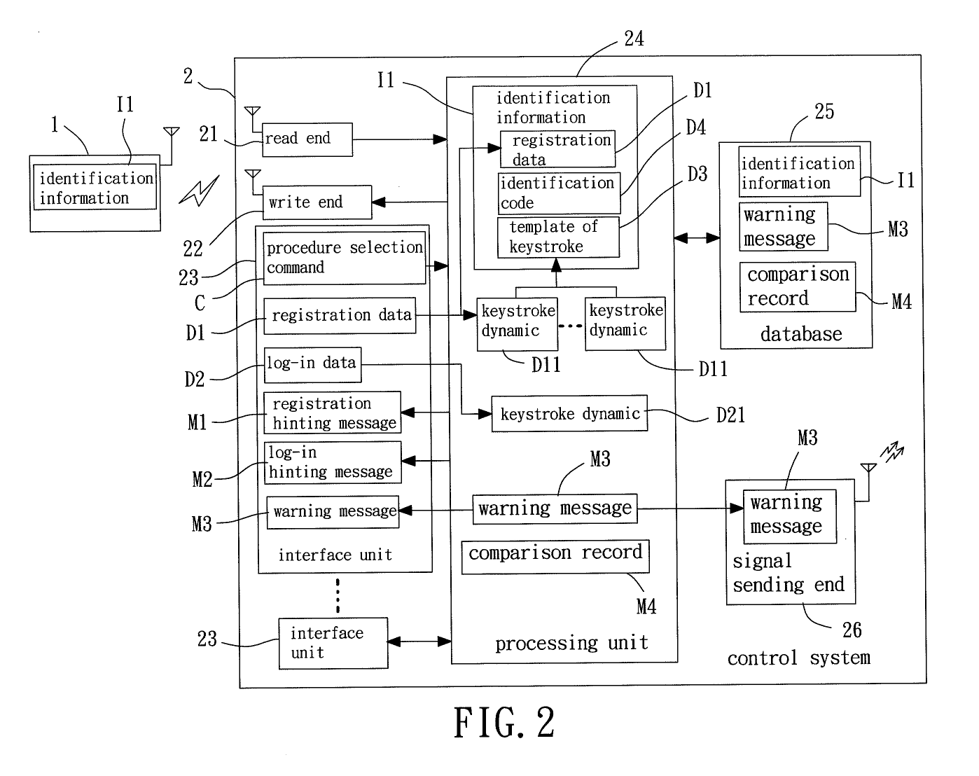

FIG. 2 shows a schematic diagram of a system for carrying out an embodiment of a method for indicating abnormal data-inputting behavior according to the present invention. The system includes an identification end 1 coupled to a control system 2. The identifying end 1 is comprised of a portable data storage device, such as a smart card. The identification end 1 can be carried by a user and can storage identification information I1, such that the control system 2 can use the identification information I1 to identify the user. In this embodiment, the identification end 1 is a non-contact type smart card conforming to ISO/IEC 10535, ISO/IEC 14443, or ISO/IEC 15693. Preferably, the smart card conforms to ISO/IEC 14443 and can be used in security systems or door access control systems. The identification end 1 includes a plurality of magnetic storage sections (not shown) using differing keys to avoid loss of data. Alternatively, the identification end 1 can be a contact type smart card conforming to ISO/IEC 7816 or ISO/IEC 7810 and can be used with automated-teller machines (ATMs). However, smart cards of other types can be used.

Still referring to FIG. 2, the control system 2 includes a read end 21, a write end 22, at least one interface unit 23, a processing unit 24, a database 25, and a signal sending end 26. The processing unit 24 is coupled to the read end 21, the write end 22, the interface unit 23, the database 25, and the signal sending end 26. The read end 21 is comprised of a device capable of reading the data at the identification end 1, such as a smart card reader. The read end 21 is electrically connected to the processing unit 24. Furthermore, the read end 21 is coupled to the identification end 1 through induction, such that the processing unit 24 can receive the data from the identification end 1. In this embodiment, the read end 21 is a non-contact type smart card reader conforming to ISO/IEC 10535, ISO/IEC 14443, or ISO/IEC 15693, or a contact type smart card reader conforming to ISO/IEC 7816 or ISO/IEC 7810. Thus, the data access between the control system 2 and the identification end 1 will not be adversely affected by swaying of the user.

Still referring to FIG. 2, the write end 22 is comprised of a device capable of writing data into the identification end 1, such as a smart card writer. The write end 22 is electrically connected to the processing unit 24. Furthermore, the write end 22 is coupled to the identification end 1 through induction, such that the processing unit 24 can transmit data to the identification end 1. The write end 22 and the red end 21 can together form a read/write end for the processing unit 24 to receive and send data. In this embodiment, the write end 22 is a non-contact type smart card writer conforming to ISO/IEC 10535, ISO/IEC 14443, or ISO/IEC 15693, or a contact type smart card writer conforming to ISO/IEC 7816 or ISO/IEC 7810. Thus, the data access between the control system 2 and the identification end 1 will not be adversely affected by swaying of the user.

Still referring to FIG. 2, the interface unit 23 is comprised of a device capable of inputting and outputting data, such as a keyboard and a screen, or a touch screen. The interface unit 23 allows the user to input data (such as a procedure selecting command C, registration data D1, or log-in data D2) to the control system 2 and allows the control system 2 to output a message (such as a registration hinting message M1, a log-in hinting message M2, or a warning message M3) to the user. The procedure selection command C includes a command for proceeding the registration procedure and a command for proceeding the log-in procedure. The commands can be selected by the user. The registration data D1 can include an account and a password. The log-in data D2 is identical to the registration data D1, such that the present invention can be used in security systems or door access control systems. Alternatively, the registration data D1 can include the password only, and the log-in data D2 is identical to the registration data D1, such that the present invention can be used in automated-teller machines. However, the present invention is not limited to these applications.

As an example, when the user uses the control system 2 for the first time and, thus, needs to proceed with the registration procedure, the user inputs the “proceeding registration procedure” of the procedure selection command C through the interface unit 23, such that the control system 2 can confirm the identify of the user. The interface unit 23 displays the registration hinting message M1 to the user, such as displaying “key-in the registration data D1 20 times”. The user has to key in the same account (such as “abed”) and the same password (such as “1234”) 20 times through the interface unit 23. On the other hand, if the user has completed the registration procedure and uses the control system 2 again, the user can enter the log-in procedure by inputting the “proceeding log-in procedure” of the procedure selection command C through the interface unit 23, such that the control system 2 can identify the user. Next, the interface unit 23 displays the log-in hinting message M2 to the user, such as displaying “key-in long-in data D2 once”. The user inputs the account “abed” and the password “1234” once. If the input of the long-in data D2 is abnormal, the interface unit 23 can display the warning message M3 to warn the user. However, the interface unit 23 can be set not to display the warning message M3.

Still referring to FIG. 2, the processing unit 24 is comprised of a device capable of proceeding with numerical arithmetic operations, such as a computer. If the procedure selection command C is “proceeding registration procedure”, the processing unit 24 outputs the registration hinting message M1 to the interface unit 23. The user keys in the registration data D1 a plurality of times through the interface unit 23, and a plurality of keystroke dynamics D11 is obtained from the registration data D1. In this embodiment, each keystroke dynamic D11 can include a down-up time, a down-down time, an up-down time, an up-up time, and a total-time, representing the typing patterns of the user during the registration procedure. Next, a template of keystroke is generated from the plurality of keystroke dynamics D11, and the processing unit 24 generates an identification code D4. Then, the processing unit 24 generates identification information I1 based on the registration data D1, the template of keystroke D3, and the identification code D4. Preferably, the identification information I1 is obtained by encrypting the registration data D1, the template of keystroke D3, and the identification code D4 (such as by AES or DES). Next, the, processing unit 24 outputs the identification information I1 to the database 25, and the identification information I1 is written into the identification end 1 through the write end 22.

On the other hand, if the procedure selection command C is “proceeding log-in procedure”, the processing unit 24 outputs the long-in hinting message M2 to the interface unit 23, and the log-in data D2 is inputted through the interface unit 23. A keystroke dynamic D21 is obtained from the log-in data D2. In this embodiment, the keystroke dynamic D21 can include a down-up time, a down-down time, an up-down time, an up-up time, and a total-time, representing the typing patterns of the user during the log-in procedure. Next, the processing unit 24 reads the identification information I1 and proceeds with comparison of data. The processing unit 24 can select an off-line mode in which the identification information I1 is read from the identification end 1, or an on-line mode in which the identification information I1 is read from the database 25. If the identification information I1 is encrypted, the processing unit 24 deciphers the identification information I1 to obtain the registration data D1, the template of keystroke D3, and the identification code D4. Then, the processing unit 24 judges whether the log-in data D2 matches the registration data D1. After checking the identification code D4, the processing unit 24 compares the keystroke dynamic D21 with the template of keystroke D3. If the keystroke dynamic D21 matches the template of keystroke D3, a comparison record M4 is generated and outputted to the database 25. If the keystroke dynamic D21 does not match the template of keystroke D3, the warning message M3 is generated and outputted to the interface unit 23, the database 25, and the signal sending end 26. Still referring to FIG. 2, the database 25 can be comprised of a conventional database allowing access to data (such as the identification information I1, the warning message M3, and the comparison record M4) by the processing unit 24. The signal sending end 26 is comprised of a wireless signal transmitter, such as a mobile phone, such that the warning message M3 can be sent to communication equipment of the user, a system manager, a security company, or the police.

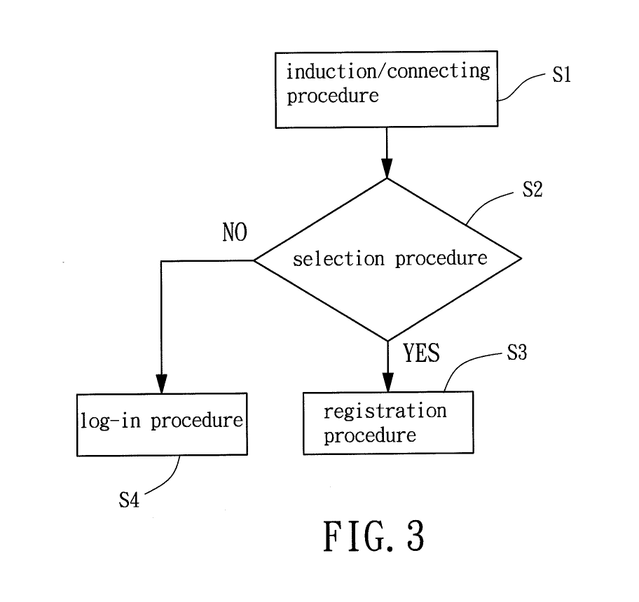

FIG. 3 shows a flowchart of an embodiment of the method for indicating abnormal data-inputting behavior according to the present invention, including an induction/connecting procedure S1, a selection procedure S2, a registration procedure S3, and a log-in procedure S4.

Referring to FIGS. 2 and 3, the induction/connecting procedure S1 includes induction and connection between the control system 2 and the identification end 1. Specifically, when the identification end 1 is located at or within an induction area of the read end 21 or the write end 22, the read end 21 or the write end 22 inducts and connects with the identification end 1, and the processing unit 24 is activated. The processing unit 24 judges whether the read end 21 or the write end 22 can access the data at the identification end 1. If yes, the procedure goes to the selection procedure S2. If no, the above induction/connecting procedure S1 is repeated.

Still referring to FIGS. 2 and 3, the user inputs the procedure selection command C in the selection procedure S2. The control system 2 receives the procedure selection command C and, according to the procedure selection command C received, sends out the registration hinting message M1 such that the user can key in the registration data D1 and enters the registration procedure S3, or sends out the log-in hinting message M2 such that the user can key in the log-in data D2 and enters the log-in procedure S4. Specifically, the interface unit 23 transmits the procedure selection command C to the processing unit 24, and the processing unit 24 judges whether the procedure selection command C is “proceeding registration procedure”. If yes, the processing unit 24 transmits the registration hinting message M1 to the interface unit 23, hinting the user to key in the registration data D1 a plurality of times, and the processing unit 24 proceeds with the registration procedure S3. If no, the processing unit 24 transmits the log-in hinting message M2 to the interface unit 23, hinting the user to key in the log-in data D2 once, and the processing unit 24 proceeds with the log-in procedure S4.

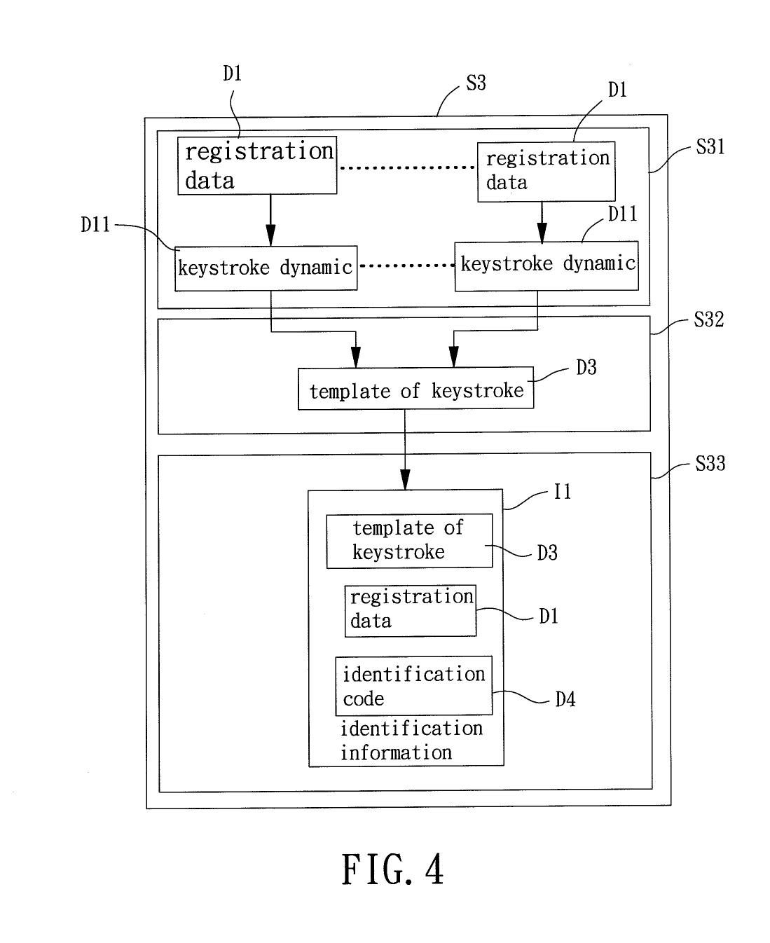

Still referring to FIGS. 2 and 3, in the registration procedure S3, the control system 2 reads the registration data D1 and generates the identification information I1, and the identification information I1 is stored in the identification end 1. With reference to FIG. 4, the registration procedure S3 includes an extracting step S31, an operating step S32, and a storage step S33.

In the extracting step S31, the control system 2 receives the registration data D1 a plurality of times and extracts the keystroke dynamic D11 in each registration data D1. Specifically, the user inputs the same registration data D1 a plurality of times through the interface unit 23, and the keystroke dynamic D11 in each registration data D1 is extracted. The keystroke dynamics D11 are stored in the database 25.

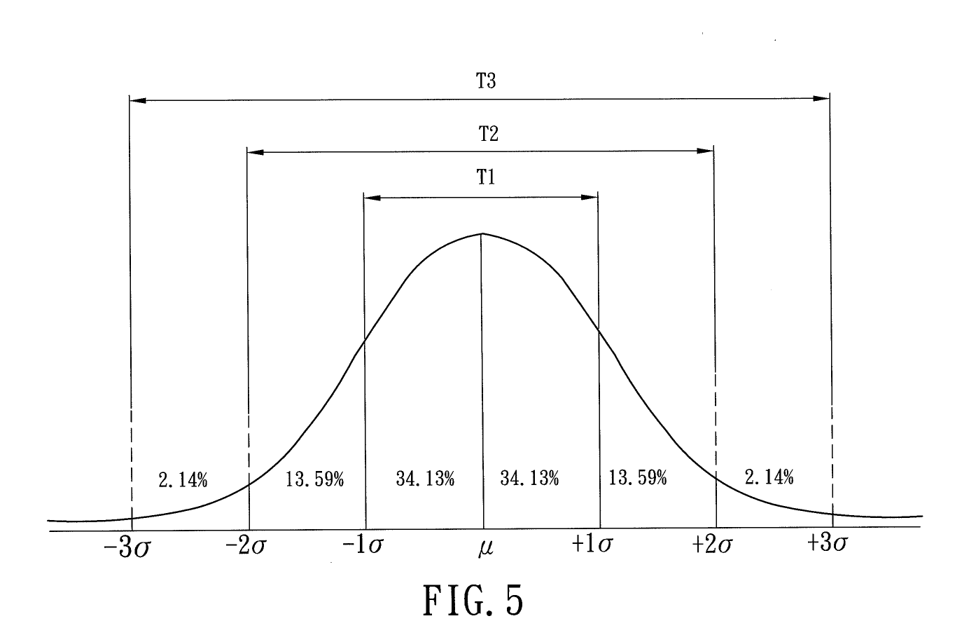

In the operation step S32, the control system 2 generates the template of keystroke D3 based on the keystroke dynamics D11. With reference to FIG. 5, in this embodiment, the processing unit 24 calculates the frequency of the keystroke dynamics D11 using statistical and generates the template of keystroke using the average value μ, and the standard variances ±σ, ±2σ, ±3σ of the keystroke dynamics D11. Based on the possibility of existence of the keystroke dynamics D11 in various standard variances ±σ, ±2σ, ±3σ, a plurality of allowable error ranges R1, R2, and R3 of the template of keystroke D3 can be set, such that the processing unit 24 can, by using the allowable error ranges R1, R2, and R3, identify whether the registration D1 is used in an unauthorized manner. In an example that the template of keystroke D3 is set to have the allowable error range R1, if the keystroke dynamic D21 of the user is beyond the allowable error range R1, the keystroke dynamic D21 is identified as not matching the template of keystroke D3. Namely, the keystroke dynamic D21 has the smallest area matching the template of keystroke D3. Likewise, if the template of keystroke D3 is set to have the allowable error range R3, the keystroke dynamic D21 has the largest area matching the template of keystroke D3. Other methods for generating the template of keystroke D3 include decision tree, distance, fuzzy logic, neural network, and genetic algorithm. Thus, the method for generating the template of keystroke D3 is not limited to the embodiment shown.

In the storage step S33, the control system 2 generates the identification code D4. Then, the identification information I1 is generated based on the registration data D1, the template of keystroke D3, and the identification code D4. The identification information I1 is stored in the identification end 1. Specifically, the processing unit 24 generated an independent identification code D4 based on the sequence the user proceeds with the registration procedure, such that the processing unit 24 can identify individual identification end 1. The processing unit 24 uses the registration data D1, the template of keystroke D3, and the identification code D4 to generate the identification information I1. The identification information I1 is preferably encrypted before it is stored in the identification end 1 and the database 25. Encryption of the identification information I1 can prevent theft. Different storage sections of the identification end 1 use different keys to prevent an unauthorized user to peep the data in all of the storage sections with the same key.

Alternatively, the user can repeat the registration procedure S3 to set a plurality of registration data D1 (such as English alphabets plus numbers or numbers only). Since the template of keystroke D3 is created from the keystroke dynamics D11 of the user, counterfeiting of the template of keystroke D3 is less likely to occur due to difficulties in counterfeiting the keystroke dynamics D11. Furthermore, the identification information I1 based on the registration data D1, the template of keystroke D3, and the identification code D4 has a small amount of data, such that that identification information I1 can be stored in the identification end 1 and can be carried by the user carrying the identification end 1.

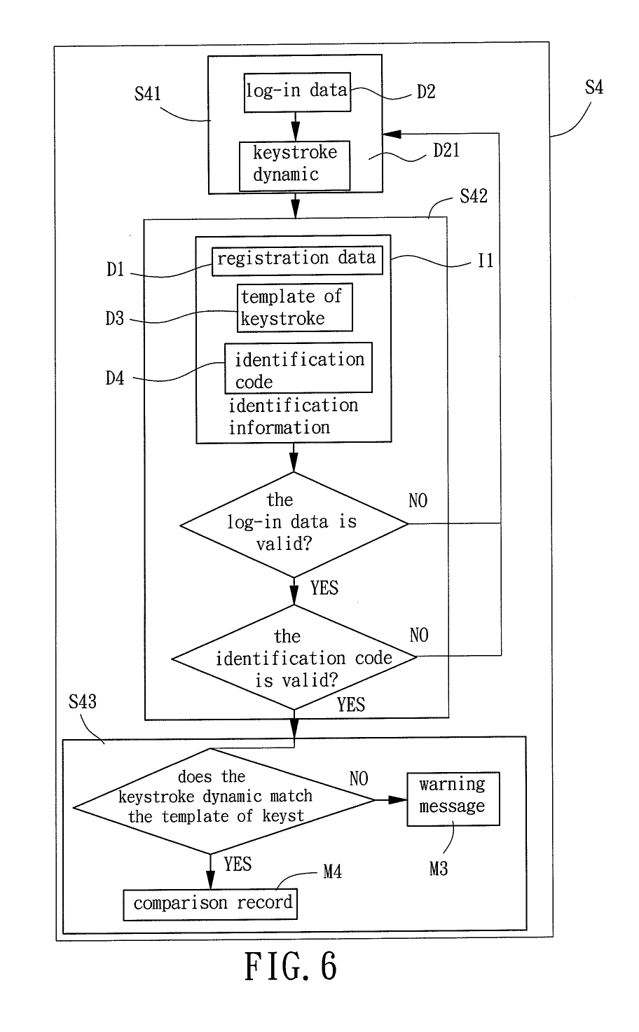

Still referring to FIGS. 2 and 3, in the log-in procedure S4, the control system 2 compares the log-in data D2 with the identification information I1. If abnormal data-inputting behavior occur (i.e., the log-in data D2 does not match the identification information I1), the warning message M3 is sent out. With reference to FIG. 6, the log-in procedure S4 includes a reading step S41, a confirmation step S42, and a comparing step S43.

In the reading step S41, the control system 2 reads the log-in data D2 once and extracts the keystroke dynamic D21 of the log-in data D2. Specifically, the user keys in the log-in data D2 once through the interface unit 23. The interface unit 23 transmits the log-in data D2 to the processing unit 24, and the processing unit 24 extracts the keystroke dynamic D21 from the log-in data D2.

In the confirmation step S42, the control system 2 reads the identification information I1 of the identification end 1 and confirms whether the identification code D4 of the log-in data D2 and the identification information I1 are valid. If yes, the procedure goes to the comparing step S43. If no, the reading step S41 is repeated. Specifically, while reading the identification information I1, the processing unit 24 can be in an off-line mode in which the identification information I1 is read from the read end 21, or in an on-line mode in which the identification information I1 is read from the database 25. Next, the processing unit 24 confirms whether the log-in data D2 inputted by the user and the registration data D1 of the identification information I1 are correct. If no, the processing unit 24 repeats the reading step S41. If yes, the log-in data D2 is identified as valid, and existence of the identification code D4 in the database 25 is checked. If the identification code D4 has not been stored in the database 25, the processing unit 24 outputs the log-in hinting message M2 to the interface unit 23, and the procedure goes to the reading step S41. If the identification code D4 has been stored in the database 25, the identification code D4 is identified as valid, and the processing unit 24 carries out the comparing step S43.

In the comparing step S43, the control system 2 compares the keystroke dynamic D21 with the template of keystroke D3 of the identification information I1. If the keystroke dynamic D21 does not match the template of keystroke D3 of the identification information I1, the warning message M3 is sent out. Specifically, the processing unit 24 judges whether the keystroke dynamic D21 matches the template of keystroke D3 of the identification information I1 based on the allowable error range R1, R2, or R3. If yes, the processing unit 24 generates the comparison record M4, and the comparison record M4 is stored in the database 25. If no, the processing unit 24 identifies the data-inputting behavior of the log-in data D2 as abnormal and generates the warning message M3. The warning message M3 can be stored by the processing unit 24 into the database 25, such that the system manager or the user can consult whether invasion of unauthorized user occurs. Alternatively, the processing unit 24 transmits the warning massage M3 to the interface unit 23 to remind the user or to scare away the unauthorized user. Alternatively, the warning message M3 can be sent by the processing unit 24 to the signal sending end 26 from which the warning message M3 can be sent to the communication equipment of the user, a system manager, a security company, or the police. Furthermore, when the user is under threat from a gangster, the user can input the log-in data D1 by abnormal time gaps, such that the signal sending end 26 can secretly send the warning message M3 to the communication equipment of the security company or the police, protecting the life and property of the user.

In the method for indicating abnormal data-inputting behavior according to the present invention, the identification end 1 is coupled to the read end 21 or the write end 22, such that the reading/writing error of the identification information I1 of the identification end 1 resulting from swaying of the user is less likely to occur.

In the method for indicating abnormal data-inputting behavior according to the present invention, the keystroke dynamics D11 are obtained from the tying patters of the user, and the keystroke dynamics D11 are utilized to generate the template of keystroke D3, rendering difficulties in counterfeiting the keystroke dynamic D21. Thus, counterfeiting of the identification information I1 is less likely to occur in the method for indicating abnormal data-inputting behavior according to the present invention.

In the method for indicating abnormal data-inputting behavior according to the present invention, the identification information I1 based on the registration data D1, the template of keystroke D3, and the identification code D4 has a small amount of data, such that that identification information I1 can be stored in the identification end 1 and can be carried by the user carrying the identification end 1.

In the method for indicating abnormal data-inputting behavior according to the present invention, the warning message M3 can be sent from the signal sending end 26 to the communication equipment of the user, the system manager, the security company, or the police, providing warning while abnormal inputting behavior occurs.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for indicating abnormal data-inputting behavior comprising:
an induction/connecting procedure: inducting and connecting an identification end with a control system;
a selection procedure: the control system receiving a procedure selecting command to allow input of registration data or a log-in data according to a type of the procedure selecting command received;
a registration procedure: the control system generating identification information based on the registration data when the procedure selecting command is the input of registration data, the identification information being stored in the identification end, the identification information including the registration data, a template of keystroke, and an identification code; and
a log-in procedure: the control system generating a keystroke dynamic based on the long-in data when the procedure selecting command is the input of log-in data, the control system comparing the keystroke dynamic of the log-in data with the template of keystroke of the identification information, the control system sending out a warning message when the keystroke dynamic of the log-in data does not match the template of keystroke of the identification information.

2. The method as claimed in claim 1, wherein the registration procedure includes the following steps:
(a) receiving the registration data a plurality of times with the control system and extracting the keystroke dynamic in each time of receiving the registration data;
(b) generating the template of keystroke with the control system by using the keystroke dynamics; and
(c) generating the identification code with the control system, and generating the identification information with the control system by using the registration data, the template of keystroke, and the identification code, and storing the identification information in the identification end.

3. The method as claimed in claim 2, wherein the keystroke dynamic includes a down-down time, a down-up time, an up-down time, an up-up time, and a total-time.

4. The method as claimed in claim 1, wherein the log-in procedure includes the following steps:
(a) receiving the log-in data once with the control system and extracting the keystroke dynamic of the log-in data;
(b) reading the identification information of the identification end with the control system, confirming whether the log-in data and the identification code of the identification information are valid, the procedure going to step (c) when the log-in data and the identification code of the identification information are valid, the procedure going to step (a) when the log-in data and the identification code of the identification information are invalid; and
(c) the control system comparing the keystroke dynamic with the template of keystroke of the identification information, the control system sending out the warning message when the keystroke dynamic of the log-in data does not match the template of keystroke of the identification information.

5. The method as claimed in claim 4, wherein the keystroke dynamic includes a down-down time, a down-up time, an up-down time, an up-up time, and a total-time.

6. The method as claimed in claim 1, wherein the registration data includes an account and a password.

7. The method as claimed in claim 1, wherein the registration data includes a password only.

8. The method as claimed in claim 1, wherein the control system includes a processing unit coupled to a read end, a write end, an interface unit, a database, and a signal sending end, the processing unit generating the warning message and outputting the warning message to the interface unit.

9. The method as claimed in claim 1, wherein the control system includes a processing unit coupled to a read end, a write end, an interface unit, a database, and a signal sending end, the processing unit generating the warning message and outputting the warning message to the database.

10. The method as claimed in claim 1, wherein the control system includes a processing unit coupled to a read end, a write end, an interface unit, a database, and a signal sending end, the processing unit generating the warning message and outputting the warning message to the signal sending end.

11. The method as claimed in claim 4, wherein the template of keystroke includes an allowable error range, the control system identifying the keystroke dynamic as not matching the template of keystroke and sending out the warning message when the keystroke dynamic is beyond the allowable error range.
